(19) United States
(12) Patent Application Publication
(10) Pub. No.: US 2026/0332929 A1
(43) Pub. Date: Oct. 22, 2026

(54) SUSPENSION SYSTEM FOR LOUDSPEAKER

(71) Applicant: Sonos, Inc., Goleta, CA (US)

(72) Inventors: Naphur van Apeldoorn, Amsterdam (NL); Timothy Ruben Scheek, Rotterdam (NL); Michael Ahrens, San Luis Obispo, CA (US); Sanjit Shankar, The Hague (NL)

(21) Appl. No.: 19/114,711

(22) PCT Filed: Sep. 28, 2023
(86) PCT No.: PCT/US2023/075366

§ 371 Date: Mar. 24, 2025

Related U.S. Application Data
(60) Provisional application No. 63/377,669, filed on Sep. 29, 2022.

(51) Int. Cl. H04R 1/06; H04R 9/04; H04R 9/06

(52) U.S. Cl. CPC H04R 1/06; H04R 9/043; H04R 9/063; H04R 2400/11

(57) ABSTRACT

There is provided a loudspeaker comprising: a frame; a diaphragm flexibly attached to the frame; a motor for driving the diaphragm; and a suspension system coupled to the frame and supporting at least part of the motor, wherein the suspension system provides an electrically conductive path to the motor. Aspects of the invention also relate to a suspension system providing an electrically conductive path.

### CROSS-REFERENCE TO RELATED APPLICATION

This Application claims the benefit of priority to U.S. Patent Application No. 63/377,669, filed Sep. 29, 2022, which is incorporated herein by reference in its entirety.

### FIELD OF DISCLOSURE

The present disclosure is related to consumer goods and, more particularly, to methods, systems, products, features, services, and other elements directed to suspension systems for use in loudspeakers and to loudspeakers or some aspect thereof.

### BACKGROUND

Consumers may desire high quality audio playback without wishing to accommodate a bulky playback device. Designing compact loudspeakers may reduce the space available so that components of the loudspeaker are closer together. This may cause some components to interact in unwanted ways.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1 is a perspective view of a portion of a first loudspeaker.

FIG. 2 is a perspective view of a first suspension system for use in the first loudspeaker.

FIG. 3 is a schematic view of the portion of the first loudspeaker of FIG. 1.

FIG. 4 is another schematic view of the portion of the first loudspeaker of FIG. 1.

FIG. 5 is a perspective view of a portion of a second loudspeaker.

FIG. 6 is a perspective view of a second suspension system for use in the second loudspeaker.

FIG. 7 is a perspective view of a third suspension system for use in the second loudspeaker.

FIG. 8 is perspective view of a frame for a third loudspeaker with two third suspension systems.

FIG. 9 is a perspective view of a fourth loudspeaker.

FIG. 10 is a perspective view of a system for driving a diaphragm of the fourth loudspeaker.

FIG. 11 is a perspective view of a fourth suspension system for use in the fourth loudspeaker.

FIGS. 12A to 12C show electrical connection points that may be provided on the fourth suspension system.

FIG. 13 shows a process for manufacturing the fourth suspension system.

FIG. 14 is an exploded view of a fifth suspension system for use in the fourth loudspeaker.

FIG. 15 is an exploded view of a sixth suspension system for use in the fourth loudspeaker.

FIG. 16 is a perspective view of a seventh suspension system for use in the fourth loudspeaker.

FIG. 17 is a perspective view of an eighth suspension system for use in the fourth loudspeaker.

### DETAILED DESCRIPTION

### I. Overview

Embodiments described herein relate to suspension systems for use in loudspeakers. Further embodiments relate to loudspeakers including the suspension systems.

Generally, the aspects described herein provide partially and fully conductive suspension systems for use in transducers and loudspeakers. Partially and fully conductive suspension systems may replace wiring within loudspeakers that may impact sound quality or reliability of the loudspeaker, especially when the loudspeaker is compact. Replacing electrical leads or wires within a loudspeaker with conductive suspension systems avoids the leads interfering with the mechanical operation of the loudspeaker. For example, a wire that is fixed only at its ends within the loudspeaker may interact with a moving component. A wire interacting with, e.g., a voice coil, in this way may cause damage to either the wire, the component to which it is connected, or to the voice coil. In other examples, a wire may vibrate or resonate during use against a frame or other component of the loudspeaker, causing undesirable noise. A wire may touch a diaphragm, causing distortion and/or other sound quality issues. A wire may inhibit movement of a moving component within the loudspeaker, such as a motor or the suspension system. Inhibiting movement of a moving component may result in an imbalance within the loudspeaker. The result may be distortion in the audio or other unwanted noises, or wear on either the wire or the moving component. Movement of the wire may also stress or fatigue the joints where the wire is connected to components, reducing reliability. By using a conductive suspension system, these issues may be reduced.

According to an aspect, there is provided a suspension system for coupling to a frame of a loudspeaker and for supporting at least a part of a motor, which may also be referred to as a speaker driver, of the loudspeaker. The suspension system provides an electrically conductive path to the motor. The motor may therefore be supplied with electrical energy from a power source via the electrically conductive path. The path may be provided on a portion of the suspension system. The suspension system may be referred to as a spider or as a speaker damper.

The suspension system may be incorporated within a loudspeaker. The loudspeaker may comprise a frame, a diaphragm flexibly or resiliently attached or mounted in the frame, and a motor for driving the diaphragm. In the loudspeaker, the suspension system may be coupled to the frame and may support at least a part of the motor.

The electrically conductive path may be provided on a surface of the suspension system. The electrically conductive path may comprise a conductive coating or partial conductive coating of the suspension system. The coating may define at least a part of the electrically conductive path. For example, the suspension system may be coated with a metallic layer. The suspension system may be formed from a plastics material. The plastics material may be any suitable material, such as polyether ether ketone (PEEK), polyetherimide (PEI), or polyphenylene sulfide (PPS). The suspension system may be manufactured by injection-molding. The metallic layer may be any suitable material, such as a copper layer, a gold layer, a silver layer, an aluminum layer, a stainless steel layer, a phosphor bronze layer, a nickel silver layer, a nickel layer, or an electroless nickel layer for example. The suspension system may be coated using a plating technique. The suspension system may be coated using deposition, such as chemical vapor deposition. The coating may be formed from a liquid conductive material. Coating is a useful way of providing a thin electrically conductive layer that may be used as an electrically conductive path. Coating techniques are suitable for applying only a thin layer, meaning only a small amount of the coating is required. The analog audio signals reproduced by loudspeakers result in an alternating current to the speaker, providing the conductive path on a surface may be an efficient way of using the conductive material due to the skin effect.

In some embodiments, the suspension system may be coated using laser direct structuring (LDS). The electrically conductive path may be defined on the surface of the suspension system using a laser. The suspension system may be formed from a plastics material that includes an additive that oxidizes when exposed to a laser. A metallic coating or plating may be applied to oxidized portions of the suspension system. The suspension system may be formed from any suitable plastics material for use with LDS, such as liquid crystal polymer (LCP), polyamide (PA6/6T), polybutylene terephthalate (PBT), polyethylene terephthalate (PET), polyphthalamide (PPA), polycarbonate (PC), acrylonitrile butadiene styrene (ABS), or PC-ABS. The coating may formed from one or more metallic layers, such as electroless nickel (EN) layer or an immersion gold (IG) layer. The coating may comprise more than one metallic layer, such as an electroless nickel layer covered by an immersion gold layer.

The suspension system may comprise a conductive material adhered to the surface of the suspension system that defines at least part of the electrically conductive path. For example, a conductive foil or tape may be adhered to a part of the suspension system using an adhesive. In other examples, a conductive adhesive may be used. The conductive foil, tape, or adhesive may include metal, such as copper, silver, gold or aluminum. Adhering conductive material allows the electrically conductive path to be applied to specific parts of the suspension system as desired. For example, the suspension system may be formed in a particular shape and using a conductive material that is adhered to the surface may allow the path to conform to this shape. Such conformation with the shape of a suspension system may improve the reliability of the electrically conductive path. The suspension system may comprise a wire adhered to or otherwise fixed to the surface of the suspension system that defines at least part of the electrically conductive path. The suspension system may comprise an embedded electrical conductor that defines at least part of the electrically conductive path. The embedded electrical conductor may comprise a wire. The embedded electrical conductor may comprise a liquid conductive material, such as a gallium-based conductor. A liquid conductive material embedded in the suspension system may have a higher fatigue resistance. The embedded electrical conductor may comprise a metallic insert. The metallic insert may comprise a ribbon or strip of metal. The metallic insert may comprise stainless steel, phosphor bronze, nickel silver, gold, silver, copper, aluminum, or another suitable material. The metallic insert may be plated. Plating the metallic insert may allow the insert to be soldered to other components and/or may prevent oxidation of the metallic insert. The metallic insert may be plated prior to being embedded within the suspension system. An embedded electrical conductor may be partially embedded or wholly embedded in the suspension system. For example, an electrical conductor may be embedded in a groove or channel formed in a surface of the suspension system. An electrical conductor may be surrounded along at least part of its length by the suspension system, such as within a hollow core or internal cavity of the suspension system. The suspension system may be formed around the electrical conductor, thereby embedding it within the suspension system. Embedding an electrical conductor may insulate the electrical conductor from other electrically conductive components and/or reduce the likelihood of damage or corrosion to the conductor.

The suspension system may define or may delimit a channel along which the electrical conductor extends, for example the suspension system may be formed around the electrical conductor. The suspension system may comprise an outer portion comprising an electrically insulative or non-conductive material within which the electrical conductor is embedded. The electrical conductor may be encapsulated by the outer portion with the ends of the electrical conductor exposed for connecting to the motor and/or to another electrical conductor. For example, the electrical conductor may be embedded within or encapsulated between two encapsulating layers, which may comprise films or laminates. The encapsulating layers may include a first portion where they overlay the electrical conductor, and at least a second portion where the encapsulating layers meet and are fused, adhered, or otherwise stuck together to provide said encapsulation. The second portion may comprise a flange, which may be referred to as a border, wing, or skirt, that extends outwardly from where the electrical conductor is encapsulated. Properties of the flange, such as the distance it extends from the electrical conductor, its shape, or its thickness, may be varied to tune the suspension system for use in a loudspeaker.

The suspension system may comprise a plurality of layers. A first and third layer may comprise or be formed from an electrically insulative material. Electrically insulative material may also be referred to as electrically non-conductive material. The first and third layers may be formed from the same material or different materials. Layers of electrically insulative material may be formed from a plastics material. The plastics material may be any suitable material, such as polyether ether ketone (PEEK), polyetherimide (PEI), or polyphenylene sulfide (PPS). The plastics material may comprise a film. A second layer comprising or formed from an electrically conductive material may be sandwiched between the first layer and the third layer. An electrically conductive layer may comprise a metallic layer. The metallic layer may comprise a stainless steel layer, a phosphor bronze layer, a nickel silver layer, a gold layer, a silver layer, a copper layer, or an aluminum layer. Where a single conductive layer is provided, a portion of the conductive layer may connect to a positive terminal of a motor of a loudspeaker and a different portion of the conductive layer may connect to a negative terminal of the motor. Such portions may be separated by an air gap or electrically insulative material. Alternatively, the conductive layer may connect to the positive or the negative terminal and the other of the positive or negative terminal may connect to a different conductive component.

The plurality of layers may comprise a fourth layer and a fifth layer. The fifth layer may comprise or be formed from an electrically insulative material, which may be the same electrically insulative material as the first layer. The fourth layer may comprise of be formed from an electrically conductive material and may be sandwiched between the third and fifth layers of the plurality of layers. The electrically conductive material of the fourth layer may be the same as the electrically conductive material of the second layer. In embodiments including two electrically conductive layers, one of the layers may connect to a positive terminal of a motor of a loudspeaker and the other of the layers may connect to a negative terminal of the motor.

In some embodiments, the layers may be differently arranged. For example, a suspension system may comprise a plurality of layers in which a first and third layer of electrically conductive material sandwich a second layer of electrically insulative material. In other examples, a suspension system may comprise two layers, where a first layer comprises electrically conductive material and a second layer comprises electrically insulative material.

Using layers of electrically conductive and insulative material in this way allows one or more electrically conductive paths to be provided along a suspension system for use in a loudspeaker. Layered materials may have improved mechanical properties and may lead to an improved lifespan of the suspension system. Furthermore, using layers may provide benefits in the ease of manufacture because the layers can be formed and combined in a straightforward manner and using existing techniques.

In a suspension system comprising a plurality of layers, each layer of the suspension system may have the same shape or substantially the same shape. In other embodiments, the layers of insulative material may have the same shape or substantially the same shape and the layer(s) of conductive material may have a different shape. For example, a layer of conductive material may comprise two separate portions of conductive material so that one portion may connect to a positive terminal and the other portion may connect to a negative terminal.

Each layer may have a similar thickness. An insulative layer may have a different thickness to a conductive layer. One or more layers may include cut-outs, variations in thickness, or other variations to alter the mechanical properties of the suspension system. For example, cut-outs may be utilized to vary a mass of the suspension system.

In a suspension system comprising a plurality of layers, electrical connections may be provided to allow connection to the motor of the loudspeaker and/or one or more other components. The electrical connections may comprise an exposed portion of a conductive layer. An exposed portion may be formed by forming a cut-out or opening in an insulative layer. In some examples, one or more electrical connectors may be attached to or formed as part of a conductive layer.

The suspension system may comprise a layer of electrically insulative or non-conductive material sandwiched between a first layer and a second layer of electrically conductive material.

The suspension system may be formed of an electrically conductive material. The suspension system may therefore define at least part of the electrically conductive path. For example, the suspension system may be formed at least partially from a metal or metal alloy, such as copper, aluminum, or steel. The suspension system may be formed at least partially from a conductive PCB material. The suspension system may be formed from a conductive polymer. Forming a suspension system from an electrically conductive material may allow for improved reliability in transferring electrical energy to the motor. For example, the suspension system may be formed from copper, aluminum, aluminum alloy, nickel, or steel. A suspension system may be formed from an electrically conductive material can be manufactured in any suitable way, including casting, molding and 3D printing.

A suspension system may provide two electrically conductive paths that are insulated from one another. Two electrically conductive paths may be formed on a suspension system using one or more of the techniques described above. A first electrically conductive path and a second electrically conductive path may be formed on a suspension system using, for example, a conductive material adhered to the surface of a non-conductive suspension system, an embedded (possibly insulated) electrical conductor, or by forming separate parts of the suspension system from electrically conductive material separated by insulating material. The first and second electrically conductive paths may form part of a circuit with a motor. The motor may therefore be driven using electrical signals passed along the first and second conductive paths.

A suspension system may comprise at least one flat spring. The flat spring may extend from a first portion, for coupling the suspension system to a frame of the loudspeaker, and a second portion, for coupling the suspension system to a motor of the loudspeaker. The electrically conductive path may be provided along the flat spring from the first portion to the second portion. Where two electrically conductive paths are provided, a first electrically conductive path may be provided on a first surface of the flat spring and a second electrically conductive path may be provided on a second surface on the flat spring. The second surface may be on an opposite side of the flat spring to the first surface.

In embodiments, a suspension system may comprise two flat springs, or more than two flat springs. The flat springs may extend from a first portion to a second portion as described above. The flat springs may be substantially symmetrical. An electrically conductive path may be provided along one of the flat springs or along each of the flat springs. Where two electrically conductive paths are provided, a first electrically conductive path may be provided along a first flat spring and a second electrically conductive path may be provided along a second flat spring. Alternatively, the first and second electrically conductive paths may be provided along the first flat spring.

In some embodiments, a suspension system may comprise a first electrically conductive path and a second electrically conductive path. The first electrically conductive path may be provided on the suspension system using one of the techniques described above, and the second electrically conductive path may be provided on the suspension system using another of the techniques described above. For example, the first electrically conductive path may comprise an electrically conductive coating on a first surface of a first electrically insulative layer while the second electrically conductive path may comprise an electrically conductive layer sandwiched between the first electrically insulative layer and a second electrically insulative layer.

In some loudspeakers, a pair of motors may be configured to drive the diaphragm. Each motor may be provided with a suspension system. A first suspension system, for a first motor, may provide a first electrically conductive path to the first motor. A second suspension system, for a second motor, may provide a second electrically conductive path to the second motor. In some examples, the motors may be driven separately, and so the suspension systems may both include two electrically conductive paths. In that case, the motors may be configured to be driven in parallel. The motors may also be configured to be driven independently. Some examples may connect the motors in series. A series connection is possible with two electrically conductive paths on the suspension system, a series connect also enables a single conductive path on the suspension system. For example, the motors may be connected in series via the first electrically conductive path and the second electrically conductive path. The motors may then be connected by a further conductive path, such as a further conductive path may be provided on a further component of the loudspeaker. In some loudspeakers, the two motors may be connected by a connecting element or support structure such as a rib. The rib may transfer the movement of the motors to the diaphragm. The further conductive path may be provided on the connecting element, such as via an electrically conductive path in the same way as discussed above for the suspension system. In other arrangements, the further conductive path may be provided on the diaphragm.

The electrically conductive path may be electrically connected to one or more components of the loudspeaker using a connection. The connection may be mechanical, such as a press or screw fit. The connection may be a welded connection or a soldered connection.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

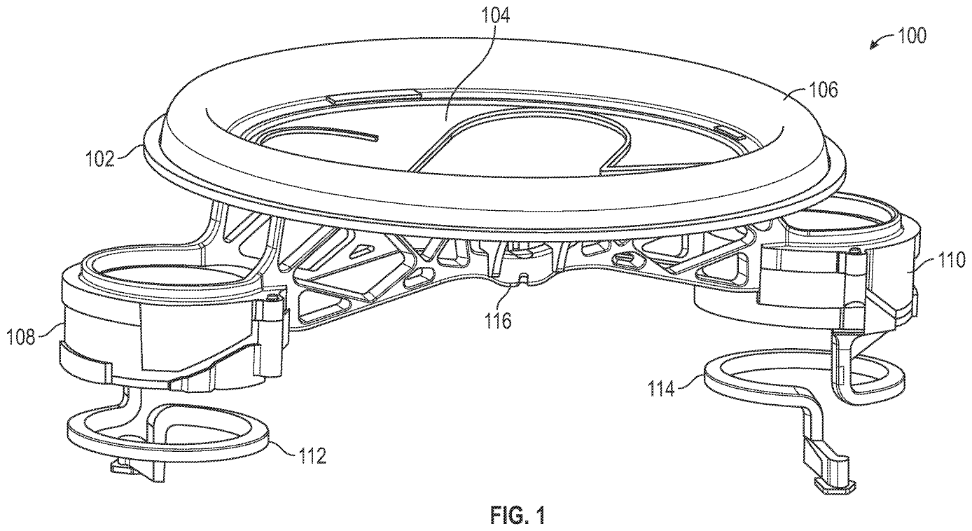

In the Figures, identical reference numbers identify generally similar, and/or identical, elements. To facilitate the discussion of any particular element, the most significant digit or digits of a reference number refers to the Figure in which that element is first introduced. For example, suspension system 120 is first introduced and discussed with reference to FIG. 1. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Example Systems and Devices

FIG. 1 shows a perspective view of part of a loudspeaker 100. In some examples, the loudspeaker 100 is at least partially housed in and/or on a playback device. The playback device, in some examples, may comprise one offered for sale by SONOS INC. including, for instance, a “SONOS ONE,” “FIVE,” “PLAYBAR,” “AMP,” “CONNECT:AMP,” “PLAYBASE,” “BEAM,” “ARC,” “CONNECT,” “MOVE,” “ROAM” “SUB,” or “SUB MINI.” Any other suitable playback devices may additionally or alternatively be used to implement the playback device(s) of example embodiments disclosed herein. In certain examples, the loudspeaker 100 may be configured to be positioned and/or operated in a vehicle, such as, for instance, an automobile, bus, train, airplane, boat, etc.

In the example of FIG. 1, the loudspeaker 100 includes a part of a frame 102. A diaphragm 104, which may also be referred to as a membrane, is mounted in the frame 102. The diaphragm 104 is flexibly connected to the frame 102 by a surround 106. The loudspeaker 100 also includes a first voice coil 108 and a second voice coil 110. The first voice coil 108 is part of a first motor or a first motor that also includes a first magnetic element (not shown) that passes through a core of the first voice coil 108. The second voice coil 110 is part of a second motor or a second motor that also includes a second magnetic element (not shown) that passes through a core of the second voice coil 110. A first suspension system 112 is coupled to the first voice coil 108. The first suspension system 112 couples the first voice coil 108 to the frame 102 or a part of a housing supporting the frame 102, although the connection between the first suspension system 112 and the frame 102 or housing is not depicted in FIG. 1. A second suspension system 114 is coupled to the second voice coil 110. The second suspension system 114 couples the second voice coil 110 to the frame 102 or a part of a housing supporting the frame 102, although the connection between the second suspension system 114 and the frame 102 or housing is not depicted in FIG. 1. A connecting member 116 couples the voice coils 108, 110 to the diaphragm 104. The connecting member 116 transfers movement from the motors, and particularly the voice coils 108, 110 to the diaphragm 104 to produce audio.

In order to move the voice coils 108, 110, electrical energy is supplied to them. The voice coils 108, 110 each include a winding wound around a central axis through which the magnetic element of the motor passes. Passing a current through the voice coil causes it to move by electromotive force. This movement may be translated to the diaphragm to create audio. The electrical energy, in the example of FIG. 1, is supplied to the voice coils 108, 110 via the suspension systems 112, 114. The suspension systems 112, 114 each include at least one electrically conductive path (not shown). Providing an electrically conductive path allows loose wiring that may otherwise get tangled or vibrate in an unwanted way to be reduced.

Although the loudspeakers described herein refer to motors including voice coils, the techniques described may be applied to loudspeakers having motors having other components for transforming electrical energy into movement for reproducing audio, such as electrostatic drivers. An electrically conductive path may be provided on any suspension, spring, or damping element used within such loudspeakers.

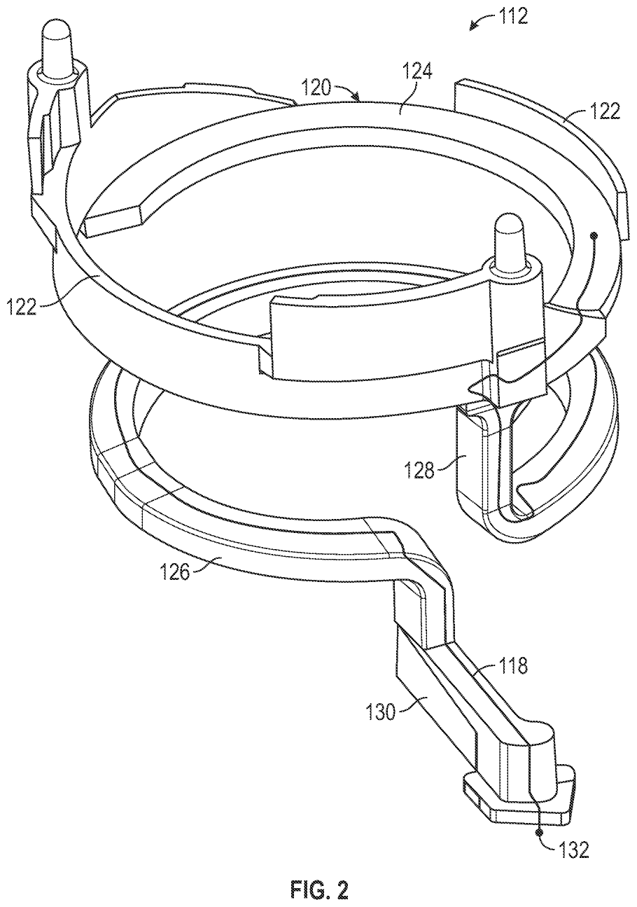

FIG. 2 illustrates an exemplary suspension system 112 that provides an electrically conductive path 118 in isolation of the other components of FIG. 1. Although the exemplary suspension system is referred to using the reference numeral of the first suspension system 112, the features described in relation to the first suspension system 112 may also be present in the second suspension system 114.

The suspension system 112 includes a coil holder 120. The coil holder 120 may be connected to the voice coil 108 using an adhesive or a fixing for axial movement of the voice coil 108. Axial movement of the voice coil 108 is along a central axis of the voice coil 108. The connection between the coil holder 120 and the voice coil 108 allows the suspension system to suspend the voice coil in the loudspeaker. The coil holder 120 has a support 122 and a flange 124. The support 122 is configured to partially surround an outer surface of the voice coil 108. The flange 124 provides a mechanical coupling between the voice coil 108 and the coil holder 130 in at least one direction.

A flat spring 126 is connected to the coil holder 120 by a member 128. A “flat” spring includes a spring which is deformed elastically out of a plane defined by the spring. The coil holder 120 is coupled to the frame 102 in use by the flat spring 126. The flat spring 126 connects to the frame 102 via a coupling 130. Other examples may use other types of spring, including helical springs.

The suspension system 112 provides the electrically conductive path 118. The electrically conductive path 118 extends between a first end 132 for connecting to a driver circuit and a second end 134 for connecting to the voice coil 108. In FIG. 2, the electrically conductive path 118 runs along a surface of the suspension system 112, along the surface of the coupling 130, flat spring 126, member 128, and coil holder 120. In other examples, the electrically conductive path may extend along any portion of the suspension system.

The electrically conductive path may be provided on a surface of the suspension system. For example, the suspension system may have an electrically conductive coating that at least partially defines the electrically conductive path. The whole suspension system may be coated with the electrically conductive coating. The suspension system may have a conductive tape or foil applied to its surface. An electrically conductive adhesive may be applied to a surface of the suspension system. The suspension system may be at least partially formed of metal, such that parts of the suspension system define the electrically conductive path. The suspension system may include an embedded electrical conductor that at least partially defines the electrically conductive path. In some examples, a combination of different electrically conductive features may define the electrically conductive path.

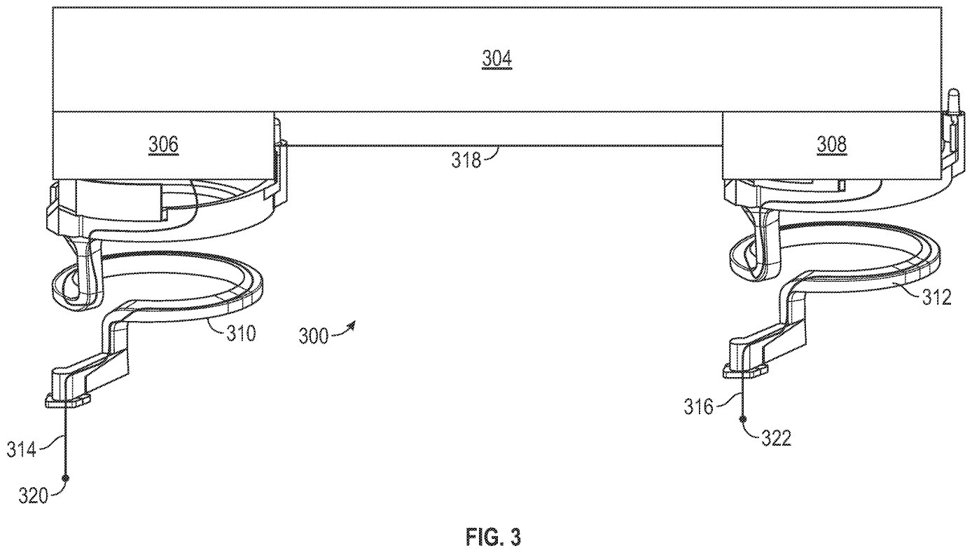

FIG. 3 shows a schematic diagram of an arrangement of part of a loudspeaker 300. The arrangement described may be applied to the loudspeaker 100 depicted in FIG. 1. In FIG. 3, the arrangement includes a diaphragm 304, a first voice coil 306 and a second voice coil 308 for driving the diaphragm 304, and a first suspension system 310 and a second suspension system 312 for coupling the respective first and second voice coils 306, 308 to a frame of the loudspeaker 300. As described in relation to FIG. 1, the loudspeaker 300 may also include a frame, a connecting element, a surround and other features of a loudspeaker but for ease of explanation these features are not depicted in FIG. 3.

In FIG. 3, the first and second voice coils 306, 308 are electrically connected in series. The first suspension system 310 provides a first electrically conductive path 314 that connects to the first voice coil 306. The second suspension system 312 provides a second electrically conductive path 316 that connects to the second voice coil 308. The first voice coil 306 is electrically connected to the second voice coil 308 by a third electrically conductive path 318. Therefore, an overall electrically conductive path runs between an end 320 of the first electrically conductive path 314 and an end 322 of the second electrically conductive path 316 via the first electrically conductive path 314, the first voice coil 306, the third electrically conductive path 318, the second voice coil 308, and the second electrically conductive path 316. Such an arrangement may allow the voice coils 306, 308 to be driven together. Such an arrangement also reduces the need for loose wiring within the loudspeaker.

The third electrically conductive path 318 may be defined at least in part by a wire connecting the voice coils 306, 308. The third electrically conductive path may be at least partially provided by one or more further components of the loudspeaker 300. For example, the diaphragm may provide part or all of the third electrically conductive path. The connecting element for connecting the voice coil to the diaphragm may provide part or all of the third electrically conductive path. The frame may provide part or all of the third electrically conductive path.

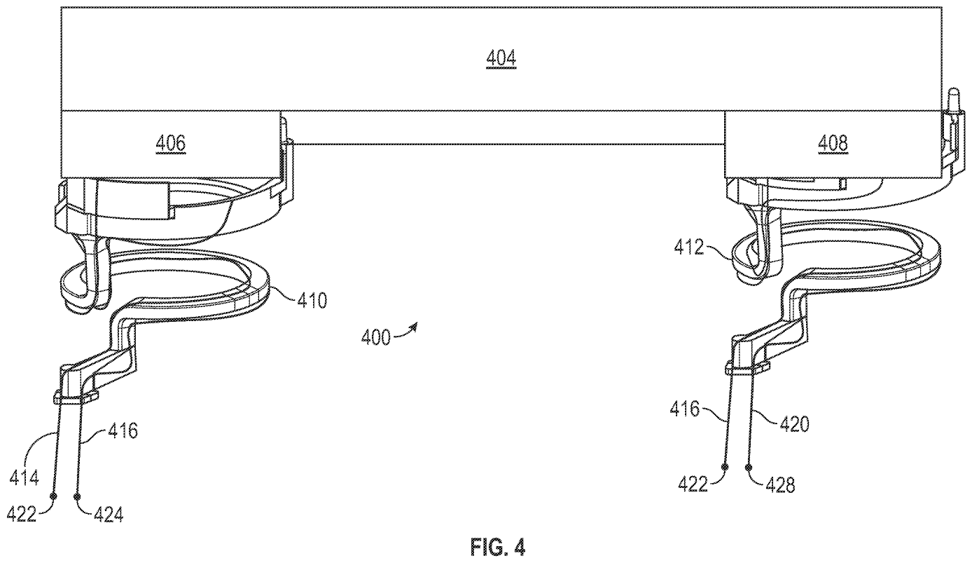

FIG. 4 also shows a schematic diagram of an arrangement of part of a loudspeaker 400. The arrangement described may be applied to the loudspeaker 100 depicted in FIG. 1. In FIG. 4, the arrangement includes a diaphragm 404, a first voice coil 406 and a second voice coil 408 for driving the diaphragm 404, and a first suspension system 410 and a second suspension system 412 for coupling the respective first and second voice coils 406, 408 to a frame of the loudspeaker 400. As described in relation to FIG. 1, the loudspeaker 400 may also include a frame, a connecting element, a surround and other features of a loudspeaker but for ease of explanation these features are not depicted in FIG. 4.

In FIG. 4, the first and second voice coils 406, 408 are electrically separated. The first suspension system 410 includes a first electrically conductive path 414 and a second electrically conductive path 416. The first and second electrically conductive paths 414, 416 are electrically insulated from one another. The first electrically conductive path 414 connects to the first voice coil 406. The second electrically conductive path 416 also connects to the first voice coil 406. The second suspension system 412 includes a third electrically conductive path 418 and a fourth electrically conductive path 420. The third and fourth electrically conductive paths 418, 420 are electrically insulated from one another. The third electrically conductive path 418 connects to the second voice coil 408. The fourth electrically conductive path 420 connects to the second voice coil 408.

Therefore, a first overall electrical path between an end 422 of the first electrically conductive path 414 and an end 424 of the second electrically conductive path 416 extends via the first electrically conductive path 414, the first voice coil 406, and the second electrically conductive path 416. A second overall electrical path extends between an end 426 of the third electrically conductive path 418 and an end 428 of the fourth electrically conductive path 420 via the third electrically conductive path 418, the second voice coil 408, and the fourth electrically conductive path 420.

By such an arrangement, the first and second voice coils 406, 408 may be driven independently. The first and second voice coils 406, 408 may be controlled using independent electrical circuits. In some examples, the first and second voice coils 406, 408 may be connected in parallel. In other examples, the first and second voice coils 406, 408 may be connected in series.

In the arrangements of FIGS. 3 and 4, the electrically conductive paths may be provided using any of the techniques described above in relation to FIG. 2.

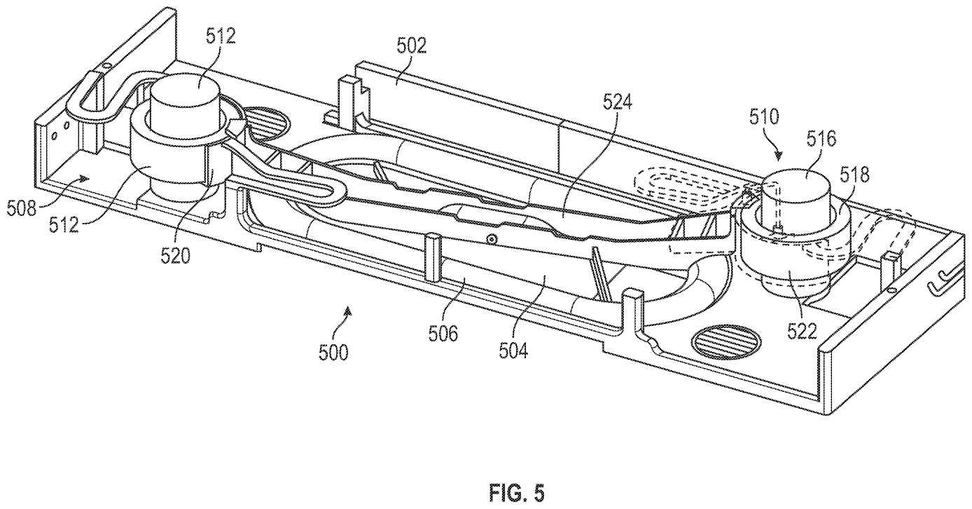

FIG. 5 shows a perspective view of part of another loudspeaker 500. The loudspeaker includes a suspension system that provides an electrically conductive path. In the example of FIG. 5, the loudspeaker 500 includes a frame 502. A diaphragm 504 is mounted in the frame 502. The diaphragm 504 is flexibly connected to the frame 502 by a surround 506. The loudspeaker 500 also includes a first motor 508 and a second motor 510. The first motor 508 includes a first magnetic element 512 and a first voice coil 514. The second motor 510 includes a second magnetic element 516 and a second voice coil 518. A first suspension system 520 is coupled to the first voice coil 514. The first suspension system 520 couples the first voice coil 514 to the frame 502. A second suspension system 522 is coupled to the second voice coil 518. The second suspension system 522 couples the second voice coil 518 to the frame 502.

The first and second suspension systems 520, 522 are connected by two connecting elements 524, which may themselves be at least partially connected along their length or integrally formed. The connecting elements 524 also connect the first and second suspension systems 520, 522 to the diaphragm 504. In use, a same signal is provided to the first and second voice coils 514, 518 causing them to move along their respective central axis. The first and second suspension systems 520, 522 also move with the voice coils 514, 518. This movement is transmitted to the diaphragm 504 via the connecting elements 524. By transmitting movement of the voice coils 514, 518 to the diaphragm 504, audio may be reproduced by the loudspeaker.

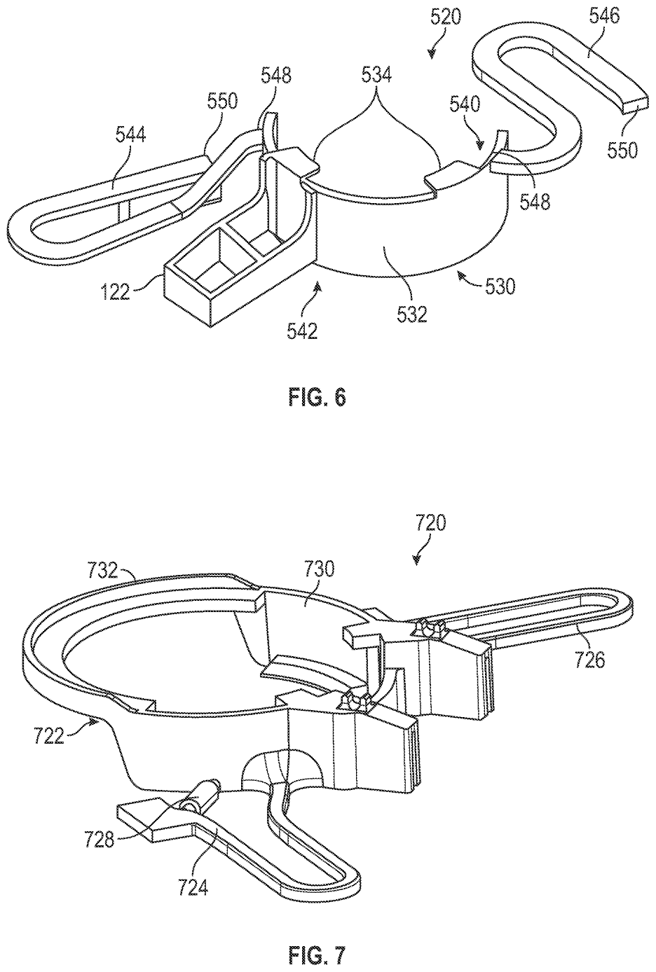

An exemplary suspension system 520 is depicted in isolation of the other components depicted in FIG. 6. Although the exemplary suspension system is referred to using the reference numeral of the first suspension system 520, the features described in relation to the suspension system 520 may also be present in the second suspension system 522.

The suspension system 520 includes a coil holder 530. The coil holder has a support 532 and a plurality of flanges 534. The support 532 is configured to partially surround an outer surface of the voice coil 514. In this example, the support 532 is generally C-shaped, or in the form of an annulus sector, because the voice coil 514 is cylindrical. In other examples, the support may have a different shape to partially surround an outer surface of a voice coil. For example, a voice coil may have a square profile, and the support of the coil holder may be flat to partially surround one side of the voice coil, two sides at right angles to one another to partially surround two sides of the voice coil, or three sides that partially cover three sides of the voice coil.

As part of the loudspeaker in FIG. 5, the coil holder 530 is mechanically connected to the voice coil 514 for axial movement of the voice coil. The mechanical connection is preferably in two directions, which are the two directions in which the voice coil 514 moves along its central axis. Flanges 534 provide such mechanical coupling between the voice coil holder 530. In other examples, mechanical coupling between the voice coil and coil holder may be in at least one direction. In other examples, adhesive or another fixing means may be used to couple the voice coil and the coil holder. Adhesive may also be combined with a mechanical coupling, such as to retain the voice coil in the coil holder.

An inner surface 540 of the support 532 faces an outer surface of the voice coil 514. Connected to an outer surface 542 of the support 532 are a first flat spring 544 and a second flat spring 546. The flat springs 544, 546 couple the coil holder 530 to the frame 502 of the loudspeaker. The flat springs 544, 546 are coupled to the coil holder 530 at a first end 548 and are coupled to the frame 502 at a second end 550. When the loudspeaker is unassembled and the suspension system is unconnected to the frame or voice coil, the second ends 550 of the flat springs 544, 546 are free ends.

The suspension system 520 provides an electrically conductive path. In FIG. 6, the suspension system 520 is formed of an electrically conductive material, and therefore the electrically conductive path is defined by the suspension system 520. The electrically conductive path may therefore extend along the suspension system 520 from a point of connection with another electrically conductive path to the voice coil 514 via the suspension system 520. For example, the voice coil 514 may electrically connect to the suspension system 520 at a flange 534 and the suspension system 520 may electrically connect to a further electrically conductive path at the second end 550 of the second flat spring 546.

The techniques described above in relation to electrically conductive paths may also be applied to the suspension system 520. For example, an electrically conductive coating may be applied to the suspension system 520. An electrical conductor may be applied to the suspension system 520. An electrically conductive tape or foil may be applied to the surface of the suspension system 520.

FIG. 7 shows an example of a further suspension system 720. The further suspension system 720 has a coil holder 722 and two flat springs 724, 726. The suspension system 720 is shown in FIG. 7 with support structures 728 used to maintain stiffness during assembly and which are removed after or during assembly.

The coil holder 722 includes a support 730 that partially surrounds an outer perimeter of the voice coil in use. The coil holder 722 also includes a semi-circular flange 732 that connects to the edges of the support 730. The semi-circular flange 732 may provide support and positioning functions for the voice coil in use as well as stiffening for the coil holder 722. The voice coil may still be received into the suspension system 720 by sliding it in the first direction perpendicular to the direction of movement in use.

The suspension system 720 may also provide an electrically conductive path. In this example, the suspension system 720 provides an electrically conductive path as a wire insert (not visible) embedded in the flat spring 724. In other examples, a suspension system 720 may provide an electrically conductive path according to any of the techniques described herein.

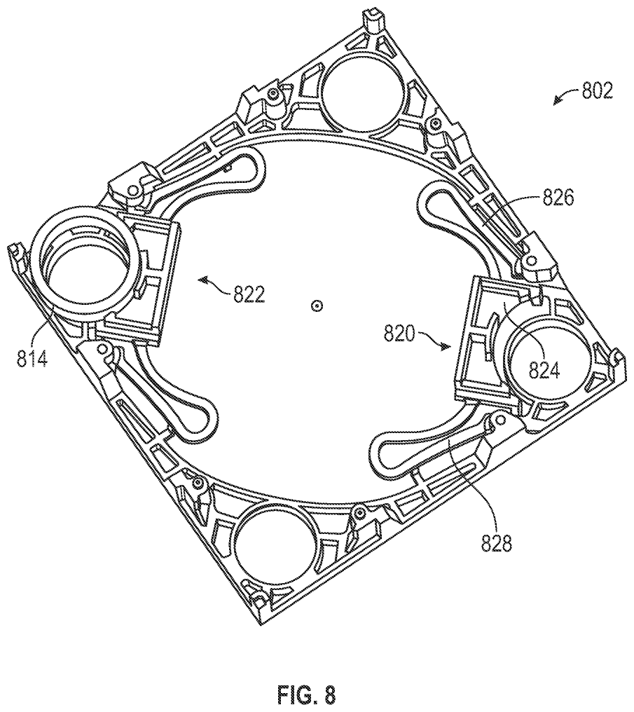

FIG. 8 shows part of a frame 802 for a loudspeaker. Two suspension systems 820 and 822 are integrally formed with the frame 802. A voice coil 814 is shown in relation to one of the suspension systems 820. The suspension systems 820, 822 each have a coil holder 824 and two flat springs 826, 828. In this example, the coil holder 824 does not incorporate flanges and instead holds the coil using adhesive.

The frame 802 and suspension systems 820, 822 of FIG. 8 are formed of plastic and are selectively coated with an electrically conductive material to form electrically conductive paths. The electrically conductive coating provides an electrically conductive path. In other examples, a suspension system 820 may provide an electrically conductive path according to any of the techniques described herein.

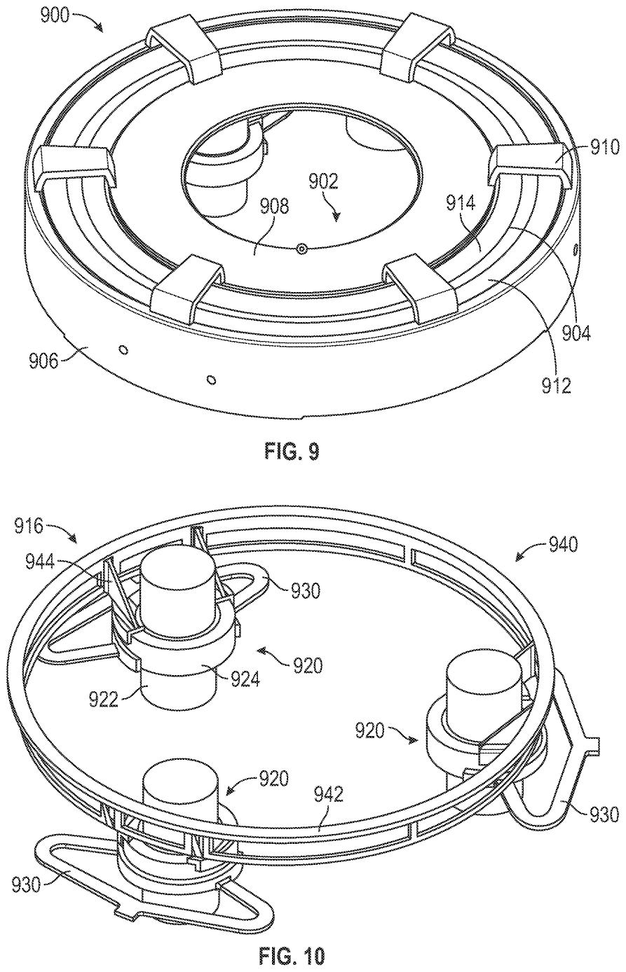

FIG. 9 shows a perspective view of a loudspeaker 900. The loudspeaker 900 includes a frame 902 and a diaphragm 904 mounted in the frame 902. The frame 904 has an outer portion 906 and an inner portion 908. The outer portion 906, inner portion 908, and diaphragm 904 are ring-shaped. The outer portion 906 is positioned so that it surrounds the diaphragm 904, while the diaphragm 904 surrounds the inner portion 908. The outer portion 906 and the inner portion 908 are connected by a plurality of links 910 that extend over the diaphragm 904 without contacting it.

The diaphragm 904 is connected to the outer portion 906 by a flexible outer surround 912. The diaphragm 904 is connected to the inner portion 908 by a flexible inner surround 914. Although not shown in FIG. 9, the loudspeaker 900 may include a further, circular diaphragm, having a central axis that is aligned with a central axis of the diaphragm 904, and that connects to frame at the inner portion 906. The loudspeaker 900 may also be combined with a further loudspeaker having a similar arrangement in a back-to-back arrangement.

The loudspeaker 900 also includes a system 916 for driving the diaphragm 904. The system 916 comprises a set of motors, a set of suspension systems connecting the motors to the frame 902 and a connecting member or support structure that connects or couples the motors to the diaphragm 904. The set of motors, set of suspension systems and connecting member are not visible in FIG. 9 because they are covered by the frame 902 and the diaphragm 904, and so are instead shown in isolation, i.e. without the frame 902 and diaphragm 904 in FIG. 10.

In the example of FIG. 10, the set of motors comprises three motors 920. Each motor includes a magnetic element 922 and a voice coil 924. The set of suspension systems comprises three suspension systems 930. A suspension system 930 is coupled to a corresponding voice coil 924. Each suspension system 930 couples its corresponding voice coil 924 to the frame 902, and specifically, in this example, to the outer portion 906 of the frame 902. The motors 920 and suspension systems 930 are evenly distributed around the circumference of a circle.

The connecting member 940 couples the diaphragm 904 to the voice coils 924. When the voice coils 924 move along their axes, the movement is translated by the connecting element 940 to the diaphragm 904, and audio may be generated as a result. The connecting element 940 has a ring-shaped structure 942 that is configured to be coupled to or contact the diaphragm 904, and connecting structures 944 that couple to respective voice coils 924.

In order to move the voice coils 924, electrical energy is supplied to them. The voice coils 924 each include a winding wound around a central axis through which the magnetic element of the motor passes. Passing a current through the voice coil causes it to move by electromotive force. Axial movement of the voice coil 924 is along a central axis of the voice coil 924. This movement may be translated to the diaphragm to create audio.

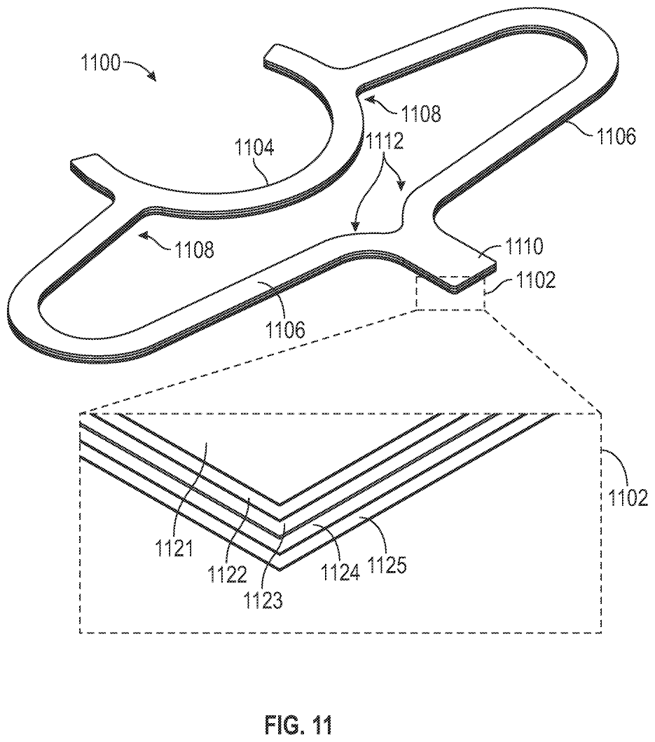

In the example of FIG. 9, the electrical energy is supplied to the voice coils 924 via the suspension systems 930. The suspension systems 930 each provide at least one electrically conductive path (not shown in FIG. 9). Providing an electrically conductive path may allow loose wiring that may otherwise get tangled or vibrate in an unwanted way to be reduced. Examples of suspension systems that include electrically conductive path(s) and that may be used in the loudspeaker 900 as one of suspension systems 930 are shown in FIGS. 11 to 17.

FIG. 11 shows an exemplary suspension system 1100 and an enlarged portion 1102 of the suspension system 1100. The suspension system 1100 may be used in the loudspeaker 900 of FIG. 9 as one or more of the suspension systems 930. The suspension system 1100 includes an electrically conductive path.

The suspension system 1100 includes a coil holder 1104. The coil holder 1104 may connect to a voice coil, such as voice coil 108, voice coil 514, or voice coil 924, using an adhesive or a fixing for axial movement of the voice coil. The connection between the coil holder 1104 and the voice coil allows the suspension system to suspend the voice coil in the loudspeaker. The coil holder 1104 connects to a lower surface of the voice coil, providing a mechanical coupling between the voice coil and the coil holder 1104 in at least one direction.

A pair of flat springs 1106 are connected to the coil holder 1104. Each of the flat springs 1106 has the same shape in this example. Each flat spring 1106 connects to the coil holder 1104 at one end 1108 and to a shared coupling 1110 at the other end 1112. The suspension system 1100 is connected to the frame of the loudspeaker, such as frame 902, via the coupling 1110.

The suspension system 1100 provides at least one electrically conductive path. The electrically conductive path extends between the coupling 1108 and the coil holder 1104. To provide the electrically conductive path, the suspension system 1100 comprises a plurality of layers comprising at least one electrically conductive layer and at least one electrically insulative layer. Using layers of conductive and insulative material may enable a suspension system to provide an electrically conductive path and may also improve how the suspension system reacts to fatigue. The electrically conductive path may comprise the electrically conductive layer. The electrically insulative layer may provide reinforcement and resistance to fatigue. Different material properties of electrically insulative and conductive materials may provide enhancements in how the suspension system reacts to the high-frequency oscillations of a voice coil when reproducing audio.

As can be best seen in the enlarged portion 1102 shown in FIG. 11, in the example of FIG. 11, the plurality of layers comprises five layers. The five layers include a first layer 1121, a second layer 1122, a third layer 1123, a fourth layer 1124, and a fifth layer 1125. The first, third, and fifth layers 1121, 1123, 1125 comprise electrically insulative layers, while the second and fourth layers 1122, 1124 comprise electrically conductive layers. The second layer 1122 is sandwiched between the first and third layers 1121, 1123 and the fourth layer 1124 is sandwiched between the third and fifth layers 1123, 1125. The electrically conductive second and fourth layers 1122, 1124 are insulated from each other by the third layer 1123.

An electrically insulative layer may be formed from a plastics material. The plastics material may comprise a polyether ether ketone (PEEK), polyetherimide (PEI), or polyphenylene sulfide (PPS). An electrically conductive layer may be formed from a metal material, such as stainless steel, phosphor bronze, or nickel silver.

One of the electrically conductive layers, such as the second layer 1122, may connect to a positive terminal of the voice coil and the other of the electrically conductive layers, such as the fourth layer 1124, may connect to a negative terminal of the voice coil. The electrically conductive layers 1122, 1124 may connect to the voice coil via the coil holder 1104 and to other components such as wiring or other electrical traces via the coupling 1110. Accordingly, the suspension system 1100 comprises two electrically conductive paths. A first electrically conductive path comprises the second layer 1122, and a second electrically conductive path comprises the fourth layer 1124.

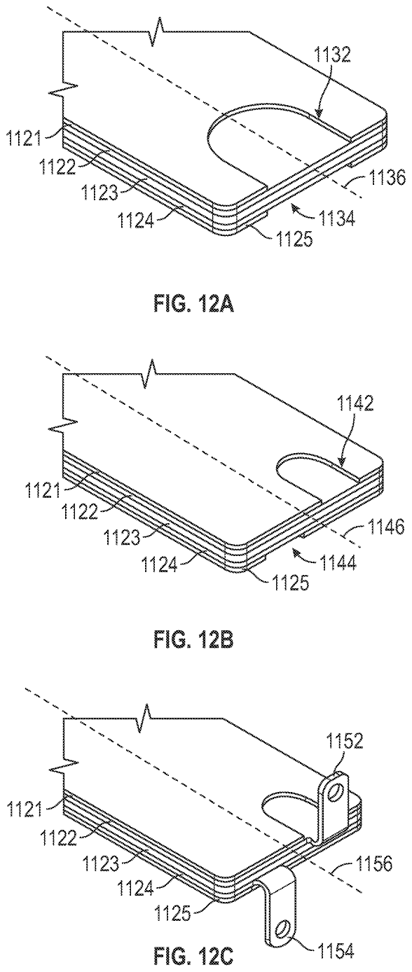

To achieve said connection to terminals of the voice coil and to other components, the suspension system 1100 may be adapted to include one or more connection points. Examples of connection points for the suspension system are shown in FIGS. 12A to 12C. Each of FIGS. 12A to 12C shows an end 1130 of the suspension system 1100, which may be part of the coil holder 1104 or of the coupling 1110.

A connection point may be formed by exposing a portion of a surface of an electrically conductive layer. FIGS. 12A and 12B illustrate examples in which a portion of a surface of the electrically conductive layers 1122, 1124 are exposed. To expose the second layer 1122, the first layer 1121 may delimit a first cut-away portion 1132. The first layer 1121 may be shaped to provide the cut-away, for example by carving or removing material from the first layer 1121 after manufacture, or by forming the cut-away into the material initially. The fourth layer 1124 may be exposed in a similar way by a second cut-away 1134 delimited in the fifth layer 1125. The voice coil or another wire may be connected to the suspension system 1100 at a connection point using solder. The second and fourth layers may be plated to enable soldering, for example they may be plated before the layers of the suspension system 1100 are combined.

As shown in FIG. 12A, the cut-away portions 1132, 1134 may be aligned with one another and may be positioned centrally, along a central axis of the portion of the suspension system 1100 in which they are formed.

Alternatively, as shown in FIG. 12B, the cut-away portions 1142, 1144 may be offset from one another, and may also be offset from a central axis 1146 of the portion of the suspension system 1100 in which they are formed. As shown in FIG. 12B, a first cut-away portion 1142 is to one side of a central axis 1146, and a second cut-away portion 1144 is to the opposite side of the central axis.

Another way to provide a connection point is shown in FIG. 12C. In this example, connection points 1152, 1154 are integrally formed with the conductive layers 1122, 1124, to which wiring or components may be directly connected. In the example of FIG. 12C, the connection points 1152, 1154 are offset from one another and relative to a central axis 1156, but in other embodiments they may be aligned with one another and/or may be aligned with a central axis.

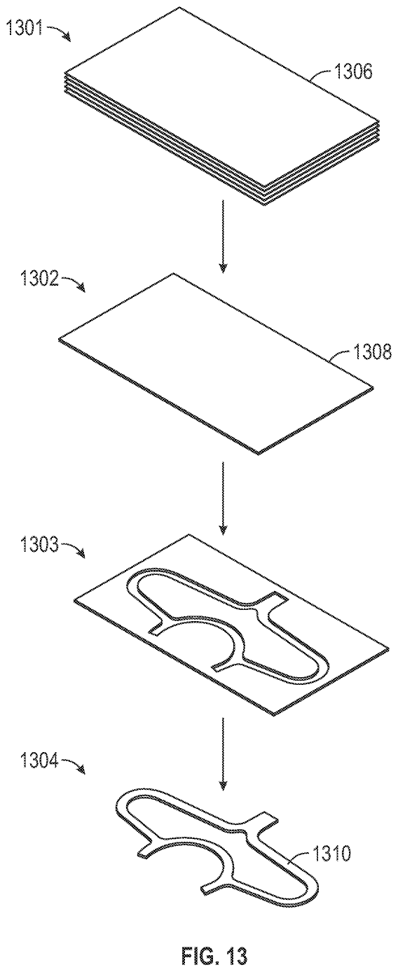

FIG. 13 illustrates a process 1300 for manufacturing a suspension system such as suspension system 1100 from a plurality of layers. The process comprises four steps, labelled 1301 to 1304 in FIG. 13. In a first step, 1301, rectangular sheets 1306 of electrically conductive and electrically insulative material may be arranged. For example, to form the suspension system 1100, five sheets of material may be layered so that three sheets of electrically insulative material are interspersed with two sheets of electrically conductive material. The electrically conductive material may be plated to allow soldering before the five sheets are arranged at step 1301.

At a second step, 1302, a flat panel 1308 may be formed by combining the sheets 1306 together. For example, the flat panel 1308 may be formed by pressing the sheets 1306 together. The sheets may be adhered together. In some examples, the flat panel 1308 may be formed by compression-molding the sheets 1306.

At a third step, 1303, the flat panel 1308 is cut, pressed, or stamped to provide, at the fourth step 1304, the completed suspension system 1310. In the third step 1303, the flat panel may be machined, such as by CNC machining, laser cutting, or water jet cutting. Alternatively, at step 1303, the panel 1308 may be stamped, such as by using fine-blanking or die-stamping.

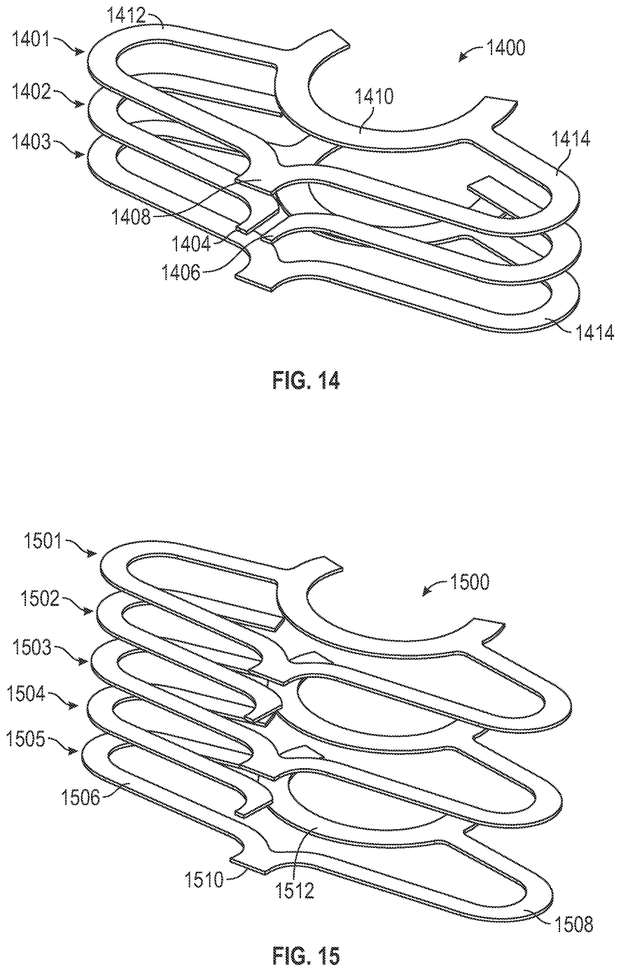

While the suspension system 1100 of FIG. 11 comprises electrically conductive layers that are the same shape as the electrically insulative layers, in other embodiments the layers may have different shapes. FIGS. 14 and 15 illustrate exploded diagrams of two exemplary suspension systems 1400, 1500, which may be used in the loudspeaker of FIG. 9, and which have electrically conductive layers.

FIGS. 14 and 15 show exploded views of the suspension systems 1400, 1500 to show how the suspension systems 1400, 1500, like the suspension system 1100 in FIGS. 11 to 13, are formed from a plurality of layers comprising electrically insulative or electrically conductive material.

In FIG. 14, the suspension system 1400 comprises three layers: a first layer 1401 comprising electrically insulative material, a second layer 1402 comprising electrically conductive material, and a third layer 1403 comprising electrically insulative material. The second layer 1402 is sandwiched between the first and third layers 1401, 1403.

In contrast to the suspension system 1100 of FIG. 11, the electrically conductive second layer 1402 of the suspension system 1400 comprises two portions 1404, 1406 that are discontinuous, such as separated by a gap 1408. The gap 1408 electrically insulates the portions 1404, 1406 from one another, so that a first electrically conductive path is formed by a first portion 1404 and a second electrically conductive path is formed by a second portion 1406. The portions 1404, 1406 are shaped to follow parts of the first and third layers 1401, 1403 by extending between a coupling 1408 of the suspension system 1400 and a coil holder 1410 of the suspension system along respective flat springs 1412, 1414. Having an electrically conductive layer that comprises two separate portions 1404, 1406 may allow two separate electrically conductive paths to be provided in the same plane of the suspension system. This may result in a reduced number of layers, and therefore reduced material use. Accordingly, a mass of the suspension system may be reduced. A resilience to fatigue may be improved by reducing the mass and number of layers.

In FIG. 15, the suspension system 1500 comprises five layers: a first layer 1501 comprising electrically insulative material, a second layer 1502 comprising electrically conductive material, a third layer 1503 comprising electrically insulative material, a fourth layer 1504 comprising electrically conductive material, and a fifth layer 1505 comprising electrically insulative material. The second layer 1502 is sandwiched between the first and third layers 1501, 1503. The fourth layer 1504 is sandwiched between the third and fifth layers, 1503, 1505.

The electrically conductive second and fourth layers 1502, 1504 of the suspension system 1500 each comprise partial layers. In other words, while the first, third, and fifth layers 1501, 1503, 1505 have the same shape and define the shape of the suspension system 1500 including the flat springs 1506, 1508, coupling 1510, and coil holder 1512, the second and fourth layers 1502, 1504 have only part of the shape of the other layers. A partial layer may have an area smaller than other layers. The second and fourth layers 1502, 1504, extend from the coupling 1510 to the coil holder 1512 along one of the flat springs 1506 only. The second and fourth layers 1502, 1504 are insulated from one another by the third layer 1503. Utilizing partial layers as in FIG. 15 uses less material and may provide a more direct path between the coupling and the coil holder.

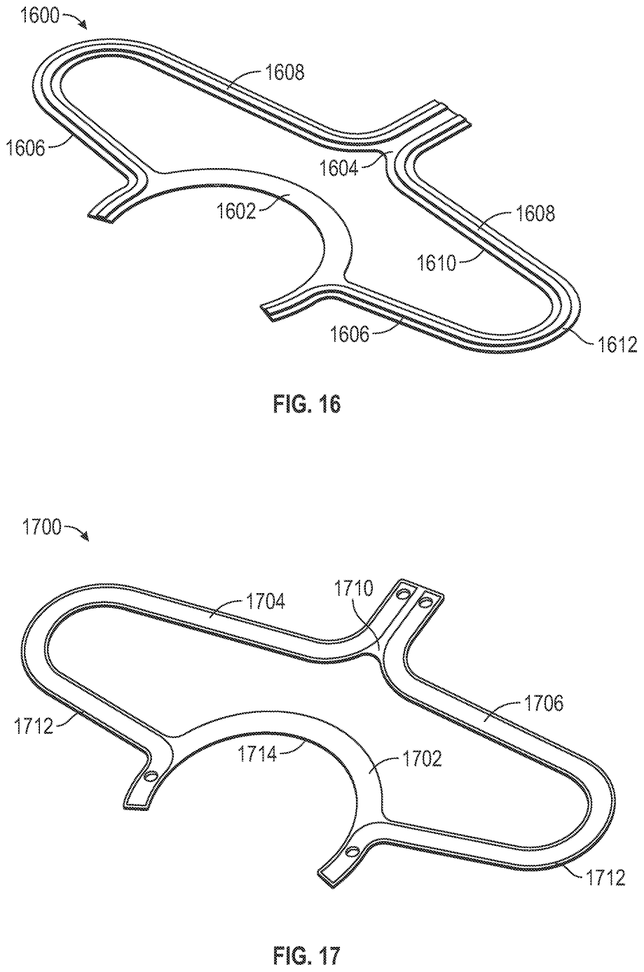

FIG. 16 illustrates a further exemplary suspension system 1600. The suspension system 1600 may be used as the suspension system 930 in the loudspeaker 900 of FIG. 9. The suspension system 1600 has a substantially similar shape to the suspension system 1100, including a coil holder 1602, a coupling 1604, and two flat springs 1606 that extend between the coil holder 1602 and the coupling 1604. While the suspension systems of FIGS. 11 to 15 included electrically conductive layers that provided the electrically conductive path(s), the suspension system 1600 comprises embedded conductive portions 1608 that form electrically conductive paths. The conductive portions 1608 are embedded or encapsulated in an electrically insulative film 1610.

The film 1610 may be formed of a plastics material. For example, the plastics material may comprise a polyether ether ketone (PEEK), polyetherimide (PEI), or polyphenylene sulfide (PPS). The portions 1608 may be formed from a metal material. The metal material may comprise stainless steel, phosphor bronze, nickel silver, gold, silver, copper, aluminum, or another suitable material.

The suspension system 1600 comprises two conductive portions 1608, which extend from the coupling 1604 to the coil holder 1602 along respective flat springs 1606. The conductive portions 1608 each define an electrically conductive path, so that the suspension system 1600 has two electrically conductive paths. Although not visible in FIG. 16, ends of the electrically conductive paths are exposed to permit connection to components of the loudspeaker.

To form the suspension system 1600, two layers of the electrically insulative film 1610 may be cut or formed and laid over the conductive portions 1608. The films 1610 may then be combined using adhesive or by applying heat such that the conductive portions 1608 are encapsulated by the films 1610.

Regions of the suspension system 1600 where the films 1610 overlap form flanges or wings 1612 extending away from the conductive portions 1608. The flanges 1612 may be tuned to provide different mechanical properties for the suspension system 1600, and particularly the flat springs 1606.

In another example (not shown), the construction may be the same as FIG. 16, but with a greater thickness of the film 1610 provided in regions away from the conductive portions 1608, so that a surface of the suspension system is generally flat rather than having a raised section over the conductive portions.

FIG. 17 illustrates a further exemplary suspension system 1700. The suspension system 1700 may be used as the suspensions system 930 in the loudspeaker 900 of FIG. 9. The suspension system 1700 provides an electrically conductive path on at least on surface by being coated with an electrically conductive material. As can be seen in FIG. 17, the suspension system 1700 comprises a base 1702, a first electrically conductive path 1704 and a second electrically conductive path 1706 formed by coating an upper surface 1708 of the base 1702. The base 1702 may be formed from a plastics material. The base 1702, as in the other suspension systems of FIGS. 11 to 16, defines a coupling 1710, two flat springs 1712, and a coil holder 1714.

The electrically conductive paths 1704, 1706 may be formed using laser direct structuring (LDS). Using LDS, a base, such as base 1702, formed from a plastics material may be injection-molded or shaped using other plastic-forming techniques. The plastics material may include an additive. The additive may oxidize when exposed to a laser, providing a surface or area to which a metallic coating or plating can be applied. A laser may be controlled to oxidize a base layer to provide the electrically conductive path or paths.

As shown in FIG. 17, two paths may be provided on the base 1702 that are separate from one another. One path 1704 extends from the coupling 1710 to the coil holder 1714 along one of the flat springs 1712, while the other path 1706 extends from the coupling 1710 to the coil holder 1714 along the other of the flat springs 1712.

The base may be formed from any suitable plastics material for use with LDS, such as liquid crystal polymer (LCP), polyamide (PA6/6T), polybutylene terephthalate (PBT), polyethylene terephthalate (PET), polyphthalamide (PPA), polycarbonate (PC), acrylonitrile butadiene styrene (ABS), or PC-ABS. The coating that forms the electrically conductive path may formed from one or more metallic layers, such as electroless nickel (EN) layer or an immersion gold (IG) layer. The coating may comprise more than one metallic layer, such as an electroless nickel layer covered by an immersion gold layer.

In another example (not shown) LDS may be used to provide conductive paths on different faces of a base. A path may be provided on a top surface and a bottom surface, for example. In that case, the conductive paths may be directly opposite each other or on different sides. (The example of FIG. 17 has two conductive paths on different sides but on the same face.

The examples above include various shapes of suspension systems. It will be appreciated that this is disclosure is not limited only to those shapes used in examples herein and can be used with any other suitable shape of suspension system.

Although the loudspeakers described herein refer to motors including voice coils, the techniques described may be applied to loudspeakers comprising other components for transforming electrical energy into movement for reproducing audio, such as electrostatic drivers. An electrically conductive path may be provided on any suspension, spring, or damping element used within such loudspeakers.

Patent applications WO 2018/056814 A1 (‘LOUDSPEAKER UNIT WITH MULTIPLE DRIVE UNITS’), WO 2019/086357 A1 (‘LOW PROFILE LOUDSPEAKER DEVICE’), WO 2022/029005 A1 (‘SPEAKER UNIT’), and WO 2022/096560 A1 (‘SPEAKER UNIT WITH A SPEAKER FRAME AND TWO OPPOSING SOUND PRODUCING MEMBRANES’), each of which are incorporated by reference, describe examples of loudspeaker units with which the suspension systems described herein may be used. Other forms of loudspeaker may also be used with the techniques described herein.

### III. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A loudspeaker comprising;
a frame;
a first diaphragm and a second diaphragm each flexibly attached to the frame;
a first motor and a second motor each for driving a respective one of the first diaphragm and the second diaphragm; and
a first suspension system and a second suspension system each coupled to the frame and for supporting at least part of a respective one of the first motor and the second motor,
wherein the first suspension system and the second suspension system each provide an electrically conductive path to the respective one of the first motor and the second motor.

2. The loudspeaker of claim 1, wherein the electrically conductive path is provided on a surface of the suspension system.

3. The loudspeaker of claim 2, further comprising an electrically conductive coating that defines at least part of the electrically conductive path.

4. The loudspeaker of claim 2, wherein the electrically conductive path is adhered to the surface of the suspension system.

5. The loudspeaker of claim 1, further comprising an embedded electrical conductor which defines at least part of the electrically conductive path.

6. The loudspeaker of claim 5, wherein the electrical conductor comprises a wire or a metal insert.

7. The loudspeaker of claim 1, wherein each of the first suspension system and the second suspension system further comprises a first layer comprising electrically insulative material and the electrically conductive path comprises a second layer comprising electrically conductive material.

8. The loudspeaker of claim 7, wherein each of the first suspension system and the second suspension system further comprises a third layer comprising electrically insulative material, and wherein the second layer is provided between the first layer and the third layer.

9. The loudspeaker of claim 1, wherein the first suspension system and the second suspension system are formed of an electrically conductive material.

10. The suspension system of claim 1, wherein the electrically conductive path is a first electrically conductive path, the first suspension system and the second suspension system each further comprising a second electrically conductive to the respective one of the first motor and d motor which is insulated from the first electrically conductive path.

11. (canceled)

12. The loudspeaker of claim 1, comprising a third motor for driving the first diaphragm, and a third suspension system is a first suspension system, and wherein the loudspeaker comprises:
a second motor for driving the diaphragm; and
a second suspension system coupled to the frame and supporting at least part of the third motor, the third suspension system providing two electrically conductive paths to the third motor, the two electrically conductive paths being electrically insulated from one another.

13. The loudspeaker of claim 11, comprising:
a third motor for driving the first diaphragm; and
a third suspension system coupled to the frame and supporting at least part of the third motor, the third suspension system providing an electrically conductive path to the third motor.

14. The loudspeaker of claim 13, wherein the first suspension system and the third suspension system are electrically connected in series via the respective electrically conductive paths of the first suspension system and the third suspension system.

15. The loudspeaker of claim 14, wherein the first diaphragm and/or a supporting structure that couples the first and third motors to the first diaphragm provides an electrically conductive path between the first and third motors.

16. The loudspeaker of claim 12, comprising:
a fourth motor for driving the second diaphragm; and
a fourth suspension system coupled to the frame and supporting at least part of the fourth motor, the fourth suspension system providing an electrically conductive path to the fourth motor.

17. The loudspeaker of claim 1, wherein the electrically conductive paths are electrically insulated from one another.
